(19) United States
(12) Patent Application Publication
(10) Pub. No.: US 2013/0066741 A1
(43) Pub. Date: Mar. 14, 2013

(54) Method of Selling Products Over a Network

(71) Applicant: Laurence B. Compton, Milwaukee, WI (US)

(72) Inventor: Laurence B. Compton, Milwaukee, WI (US)

(21) Appl. No.: 13/614,403

(22) Filed: Sep. 13, 2012

Related U.S. Application Data
(60) Provisional application No. 61/533,979, filed on Sep. 13, 2011.

(51) Int. Cl. G06Q 30/00

(52) U.S. Cl. 705/26.7; 705/26.8

(57) ABSTRACT

A method of selling products of a network includes creating at least one product list. The products on the product list are individually presented to a customer. A disposition command is received from the customer for each individually presented product. The products are allocated in a virtual shopping care based upon the received disposition command.

### CROSS REFERENCE TO RELATED APPLICATION

This application claims priority from U.S. Provisional Application Ser. No. 61/533,979 filed on Sep. 13, 2011, which is hereby incorporated by reference in its entirety.

### FIELD OF THE DISCLOSURE

The present disclosure relates to a method of selling products. More specifically, the present disclosure relates to a method of selling products over a network.

### BACKGROUND

Internet retailers often present entire product offerings on a web site that requires the customer to browse through all of the products listed in order to make a purchasing decision. Some retail web sites allow the customer to perform limited searching or sorting operations in an attempt to narrow the product list. In some instances, each product may have a separate page with a description of that product. A customer must navigate back and forth between these product pages and the general listing of the offered products. However, this current manner of Internet retail is inefficient for customer browsing and fails to provide individualized customer service in the on-line shopping experience.

### BRIEF DISCLOSURE

An exemplary embodiment of a method of selling products over a network includes creating at least one product list, the product including a plurality of individual products. At least one product list is provided to a customer through a secure web site accessed over the network. The product from the at least one product list is individually presented to the customer. A disposition command is received from the customer for the individually presented product. Upon receiving the disposition command, the product is allocated in a customer virtual shopping cart based upon the disposition command. Further upon receiving the disposition command, a next product from the product list is individually presented to the customer. Completion of an order of the products in the customer virtual shopping cart by the customer is facilitated.

An exemplary embodiment of a method of selling books over the Internet includes creating at least one customer book list. The at least one customer book list is individually tailored to a customer based upon at least one of the customer's purchasing history and the customer's book preferences. The book list includes descriptions of a plurality of books. The customer book list is provided to the customer by storing the customer book list in a secure customer profile. The secure customer profile is accessed by the customer through the internet. A description of a book from the customer book list is individually presented to the customer. A disposition command is received from the customer for the book description list. Upon receiving the disposition command, the book is allocated in a virtual shopping cart of the customer based upon the received disposition command. Further upon receiving the disposition command, the description of a next book from the customer book list is individually presented to the customer. Completion of an order of the books in the virtual shopping cart by the customer is facilitated.

A non-transient computer readable medium is programmed with computer readable code that upon execution by a computer, causes the computer to carry out a series of actions. In an embodiment, the computer receives book selections from a seller inventory from a seller representative to create at least one customer book list individually tailored for a customer. An automated electronic message is sent to the customer, notifying the customer of the at least one customer book list. Secure log-in credentials are received from the customer and upon receipt, the customer is provided access to a secure customer account that includes the at least one customer book list. Each book in the customer book list is individually presented to the customer. The customer is prompted for a disposition command for each individually presented book. A disposition command is received for each book. A next book from the customer book list is individually presented to the customer. Each book from the customer book list is allocated in a virtual shopping cart based upon the received disposition command for each individually presented book. The purchase of the books allocated to the virtual shopping cart is facilitated.

### BRIEF DESCRIPTION OF THE DRAWINGS

FIG. 1 is a system diagram which depicts an exemplary embodiment of a system for selling products over a network.

FIG. 2 is a flow chart that depicts an exemplary embodiment of a method of selling products over a network.

FIG. 3 is a flow chart that depicts an exemplary embodiment of a more detailed portion of a method of selling products over a network.

FIG. 4 is a flow chart that depicts a still further exemplary embodiment of a more detailed portion of a method of selling products over a network.

FIG. 5 is a flow chart depicting an exemplary embodiment of a method of providing a product list to a customer, as may be used in an embodiment of a method of selling a product over a network.

### DETAILED DISCLOSURE

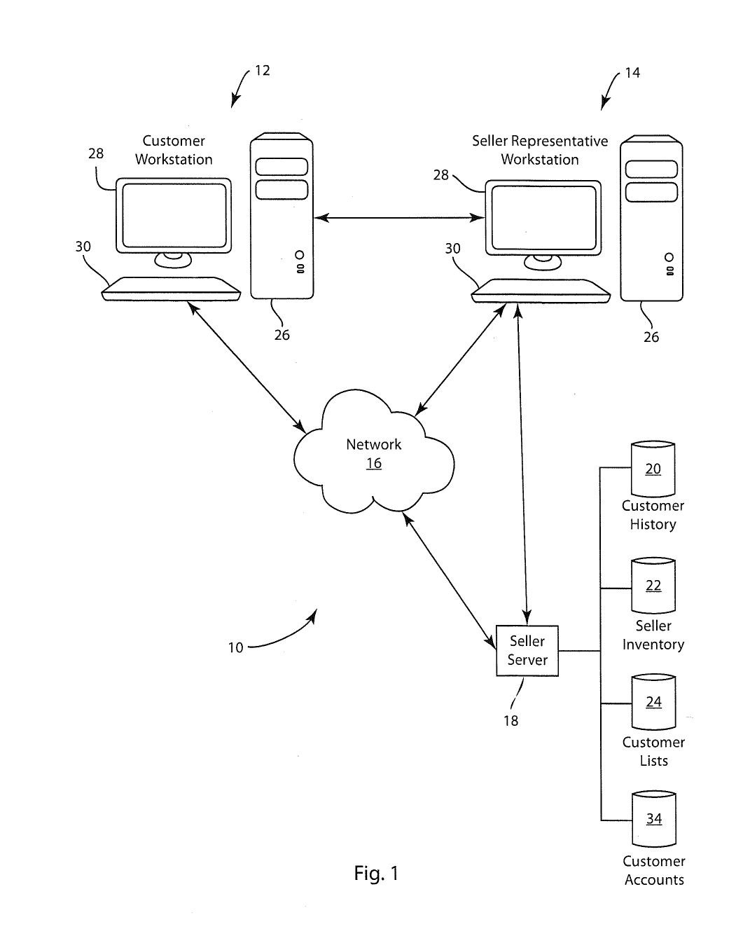

FIG. 1 depicts an exemplary embodiment of a network system 10 upon which embodiments of the method of selling a product over a network as disclosed herein may operate. It is to be understood that the network system 10 is merely exemplary of one such embodiment and it will be recognized that alternative systems and structures may be used to implement the methods as disclosed herein.

The network system 10 includes a customer workstation 12 and a seller representative workstation 14 that are communicatively connected through a communications network 16, which is exemplarily the Internet, but will be recognized as also including alternative communication networks and protocols.

Customer workstation 12 and seller representative workstation 14 are recognized as being any of a variety of computers or other communicative devices, exemplarily, but not limited to, desk top computer, laptop computers, tablet computers, or smart phones. Exemplarily both workstations 12, 14 include a central processing unit 26 that executes computer readable code such as to communicatively connect to and through the communications network 18, as well as to function in the manner as disclosed herein. Exemplarily, the workstations 12, 14 include a graphical display 28 that visually presents data as disclosed herein by the presentation of one or more graphical user interfaces (GUI). The workstations 12, 14 further exemplarily include a user input device 30, such as, but not limited to, a keyboard, mouse, or touch screen that facilitate the entry of data as disclosed herein by a respective customer or seller representative operating one of the workstations 12, 14.

The workstations 12, 14 also facilitate direct communication 32 between a respective customer and a seller representative associated with the customer workstation 12 and the seller representative workstation 14, respectively. Such direct communication can either be conducted across network 16 using the workstations 12, 14, or may be conducted directly between the customer and seller representative in person, or over a dedicated communication service, such as land line, wireless telecommunications, or LAN/WAN.

A seller server 18 is also communicatively connected to the communications network 16. The seller server 18 may also be directly communicatively connected to the seller representative workstation 14. The seller server 18 stores and supports the seller web site and customer user interface, as will be described in further detail herein and at least portions of which are accessible through the network 16 by the customer workstation 12. The seller server 18 may establish both public and private accessible web pages that can be accessible by the customer workstation 12 through the entry of a customer log in identification and password, as detailed below. The seller server 18 provides these accessible web pages by permitting access of the workstations 12, 14 to computer readable code stored on a non-transient computer readable medium associated with the seller server 18, and the workstations 12, 14 execute the computer readable code to present the GUIs of the web pages.

Embodiments of the seller server 18 can further have communicative access to one or more of a variety of computer readable mediums for data storage. The access and use of data found in these computer readable media are used in carrying out embodiments of the method as disclosed herein. Non-limiting examples of the stored data can include a customer history 20, a seller inventory 22, customer lists 24, and a customer accounts 34, as will be described in further detail herein.

The customer history 20 exemplarily includes a record of customer past purchases, including identification of products purchased, quantities, and categorical information regarding the products purchased by the customer. The customer history can either be separate from or integrated into a specific customer account 34, which is exemplarily identified by a user name and password and is associated with customer profile or other customer information. The customer account or customer profile can include information such as revealed customer preferences, browsing history, type of business or interests or other information related to the customer.

The seller inventory 22 can include an identification of the products currently available for the seller to supply to the customer. The seller inventory 22 can exemplarily include an identification of a status of a product, such as whether a product is in stock and stock remaining, back ordered, or discontinued.

The customer product lists 24 are created in the manners as described herein and can be separately stored for later retrieval and/or use by a seller representative, through the seller representative workstation 14. As will be described in further detail herein, one or more of the customer product lists 24 can be placed in or in association with a customer account 34.

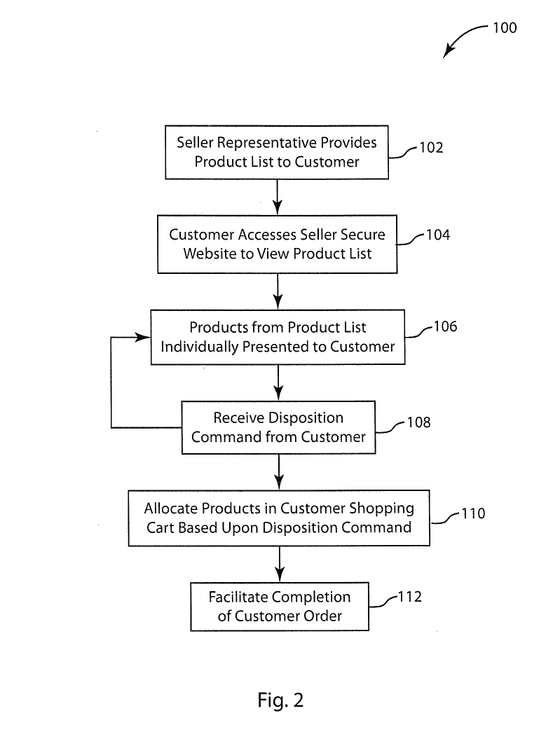

FIG. 2 is a flow chart that depicts an exemplary embodiment of a method of selling a product over a network. By means of example, the present disclosure will focus on the specific example wherein the products are books, and the network used to sell the books is the Internet. However, it will be understood that alternative embodiments may sell other products, including, but not limited to stuffed animals, toys, or puppets. At 102 a seller representative provides a product list, which is exemplarily a customer book list, to the customer. The customer book list will be described in further detail herein; however, in general, the customer book list is created by the seller representative through the seller representative workstation 14 (FIG. 1) to be individually tailored to a specific customer. This individual tailoring of the customer book list can be performed in a variety of ways, but may include reference to a customer purchasing history, or other revealed customer preferences in books for purchase.

The customer book list is provided at 102 to the customer by adding the customer book list to a customer's profile stored on the seller server 18 (FIG. 1). The customer is able to access the customer book list through the seller server 18 by securely logging in to gain access to the customer profile wherein the customer book list is stored. The seller representative can notify the customer that a new customer book list has been added to the customer's account by providing an electronic communication, such as an email or text message with a link to the log in page for the secure log in access to the seller server with a short notification that a new customer book list has been provided. Such electronic communication can be automatedly generated and sent to the customer by the seller server 18 through the communications network 16 (FIG. 1).

At 104 the customer accesses the customer's secure customer account through the seller's web site in order to view the customer book list. As referenced above, the customer has a unique identification and password that will grant the customer access to the customer account on the seller server. In the customer account or as part of a secure web page individualized to the customer, the customer can view the customer book list in a GUI as presented on the graphical display of the customer workstation (FIG. 1).

As shown at 106 the books from the customer book list are individually presented to the customer in the GUI presented by the graphical display of the customer workstation. The individual presentation of the books from the customer book list can include a description of the individual book presented to the customer. This description can include identification of a book title, book subject matter, or book author, a picture of the book cover, a reading level of the book, book series, book format, or other descriptive information regarding the individually presented book. In embodiments, the customer book list defines the particular order in which the books and book descriptions are presented. The individual presentation of the book from the customer book list also includes a plurality of GUI objects that solicit the customer to enter a disposition command regarding the individually presented book. In an example, the GUI presents “yes”, “no”, and “maybe” buttons that may be selected by the customer to indicate the customer's purchasing decision regarding the individually presented book.

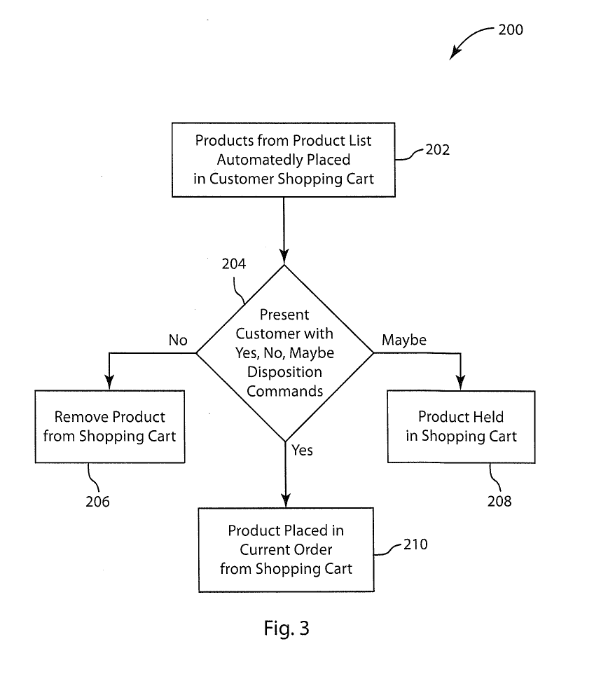

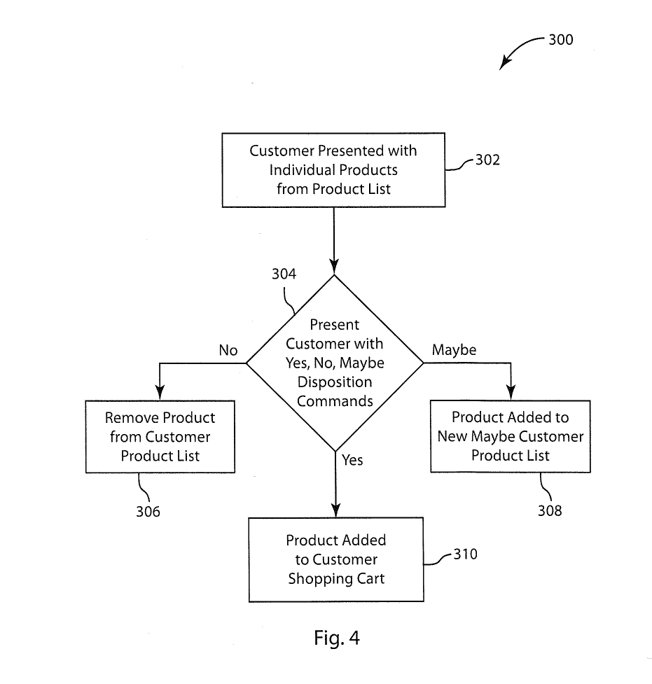

At 108 the seller server receives a disposition command from the customer through the customer's selection of one of the GUI objects. After the disposition command, exemplarily noted above as a “yes” disposition command, a “no” disposition command, or a “maybe” disposition command, the seller's server performs two actions, which may occur in any specific order, or may occur simultaneously. In one action, the seller server causes the GUI to individually present a next book from the customer book list. As disclosed above, in an embodiment, the customer book list defines a predetermined order in which the books are individually presented. Therefore, the next book presented according to the order in the customer book list. Such presentation of the next book being the same as described above. The seller server will continue to perform this action in response to a received disposition command until each book in the customer book list has been individually presented. Additionally, the seller server allocates the individually presented book into a customer virtual shopping cart based upon the received disposition command. Various embodiments of this allocation will be described in further detail herein with respect to the methods of FIGS. 3 and 4. In general effect, this allocation populates an order by the customer in the customer's virtual shopping cart with books that receive a favorable or “yes” disposition command. In one embodiment, the seller server allocates each individually presented book in the virtual shopping cart when each disposition command is received. In an alternative embodiment, the seller server waits until all books in the customer book list have received a disposition command before allocating the books from the customer book list.

At 112 the seller server facilitates the completion of the customer order by soliciting and receiving confirmation of the customer's order, and routing the order to the necessary system or personnel of the seller for fulfilling the order. In some embodiments, the seller server may facilitate the completion of the order by soliciting and receiving customer payment and/or delivery information.

FIG. 3 is a flow chart that depicts an exemplary embodiment of a method portion 200 that more fully details an embodiment of the manner in which books are allocated in the customer's virtual shopping cart based upon the disposition command received at 110 in FIG. 2.

At 202 the books from the customer book list are automatedly placed in the customer's virtual shopping cart. This step can be performed either upon the original creation and provision of the customer book list to the customer, or could exemplarily occur at the time when the customer initially accesses the seller' secure web site in order to view the customer's virtual shopping cart. In a merely exemplary embodiment, each of the books placed in the shopping cart have a default quantity of one book. At 204, the customer is presented with the previously described yes, no, and maybe disposition commands, such as is described above in further detail with respect to 106 and 108 in FIG. 2. If a no disposition command is received, then that book is removed from the customer's virtual shopping cart at 206. If a maybe disposition command is received, then the book is held in the customer's virtual shopping cart at 208. If a yes disposition command is received from the customer, then, at 210, the book is placed in a current order of the virtual shopping cart. In some embodiments, the changes to the books in the virtual shopping cart happen as each disposition command for each book on the customer book list is received. In other embodiments, all of the disposition commands are held in queue until the customer has completed a review of all books in the customer book list and a disposition command has been received for each book in the customer book list. Then the contents of the virtual shopping cart is modified according to the received disposition command.

In one non-limiting example, such allocation in the virtual shopping cart between the yes disposition commands and the maybe disposition commands may be implemented by modifying an order quantity for an individual book, whereby if the yes disposition command is received, then the order quantity is registered as one, whereas if a maybe disposition command is received, the order quantity may be identified as zero. Therefore, if an order is fulfilled out of the customer's virtual shopping cart, only those books with a non-zero quantity would be sent to the customer, while the books with a maybe disposition command would still be retained in the virtual shopping cart for later consideration by the customer.

One feature of the exemplary embodiment of method 200 is that the customer opts out of purchasing the books from the customer's book list, which may facilitate increased sales to the customer.

FIG. 4 is a flow chart that depicts an exemplary embodiment of an alternative method 300 of allocating products within the customer's virtual shopping cart based upon a received disposition command, as described above with respect to FIG. 2, and which is alternative to the exemplary method 200 described with respect to FIG. 3. In the method 300, the customer is presented with individual books from a customer book list at 302 as described above with respect to 106 in FIG. 2. In the exemplary embodiment of the method 300, the books in the customer book list are not automatically placed in the customer's virtual shopping cart, but the customer book list is a separate file associated with the secure customer account. At 304, similar to the embodiments described above, the customer is presented with yes, no, and maybe disposition commands with respect to each of the individually presented books and associated descriptions.

If a no disposition command is received, then at 306, the book is removed from the customer book list. If a maybe disposition command is received, then at 308 the book is added to a new “maybe” customer book list. If a yes disposition command is received, then at 310 the book is added to the customer's virtual shopping cart. As previously described above, in various embodiments, the received disposition commands may be acted upon as each disposition command is received, or may be held until a disposition command has been received for each of the books in the customer book list. In a still further embodiment, the received disposition command may be acted upon after receiving an additional “confirmation” or “save selections” command.

The method 300 is different from other embodiments in that the maybe disposition commands result in the creation of a new customer book list that holds those books that the customer wants to retain for further consideration. In an embodiment, the maybe customer book list retains books placed on that list for a set time period, exemplarily 30 days, 45 days, or 60 days; however, these date ranges are not intended to be limiting in any respect to the various types of lengths that may be used in association with the maybe customer book lists, including holding books on the maybe customer book list until otherwise disposed of by the customer. Thus, in embodiments, the customer is presented with a customer book list, and at the end of the presentation of each individual book, each hook on the list has been either deleted or moved to another file. The embodiment of the method 300 has the further feature of keeping the customer's virtual shopping cart clear of products that are not selected by the customer for immediate purchase.

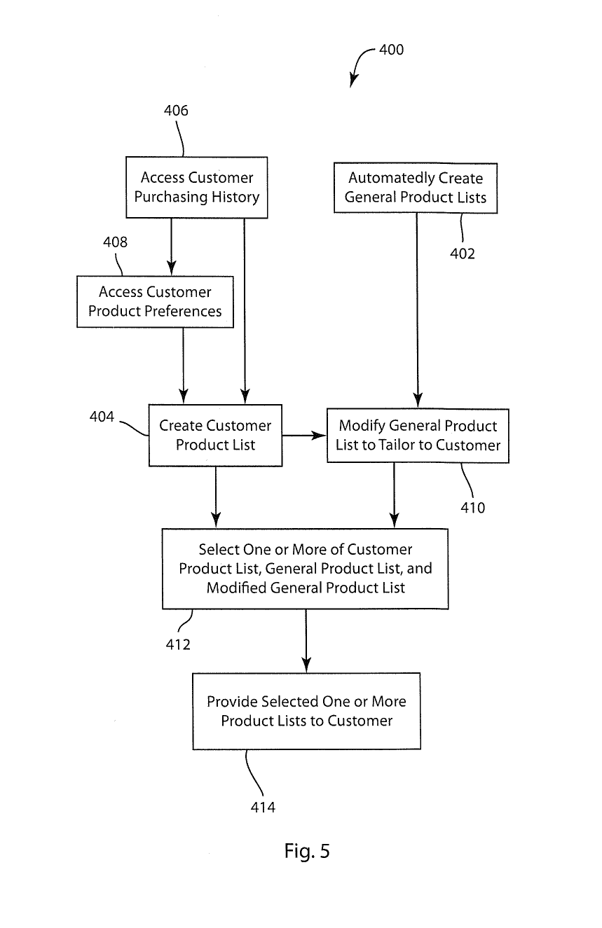

FIG. 5 is a flow chart that depicts an exemplary embodiment of a method 400 of creating and/or selecting one or more product lists, as provided to the customer at 102 in FIG. 2. As described above, the product lists referred to with respect to the method 400 can be any of a variety of lists as described in further detail herein, and for exemplary purposes will be described in the specific embodiment of the one or more book lists for a customer desirous to purchase books. At 402 the seller server 18 (FIG. 1) can automatically create general book lists based upon at least one characteristic of the plurality of books. These general book lists can exemplarily include such categorical lists as “new release” books that all share the same characteristic of being newly offered by the seller. Other general book lists could exemplarily include lists segmented by the characteristic of book topic, such as, fiction, nature, animals, educational, or otherwise. Still other general book lists could be segmented by other book characteristics, such as author, character or series, or reading level. Still further examples of characteristics may include book format such as, but not limited to hard bound, paperback, or board books. It is understood that various other types of book characteristics may be used by the seller server to automatedly create these general book lists at 402.

At 404 a seller representative uses the seller workstation to create a customer book list. The customer book list created at 404 is populated with books identified by the seller representative that the seller representative believes are desirable for the specific customer to which the customer book list is directed. This can be determined by one or both accessing a customer purchasing history at 406 and accessing customer product preferences at 408. The customer purchasing history and customer product preferences can both be stored at computer readable media communicatively accessible by the seller server and/or seller workstation. The customer purchasing history can indicate various books and book topics or other categorical information of books previously purchased by the customer. The customer product preferences can come from alternative sources of revealed preference, exemplarily records of customer inquiries, or other direct communication between a seller representative and the customer. Notes from such inquiries or other direct communications may be stored to the customer's account, or a version of such account accessible by the seller representative. Through such communications between the seller representative and the customer, particular interests or needs of the customer may be conveyed. In still further embodiment, the customer navigation or browsing through the seller's product pages on the seller's web site can be stored and analyzed to evaluate the browsing interests of the customer for further revealed preferences. Alternatively, the seller server can monitor and store the specific books and received disposition commands received from the customer in response to previous customer book lists. This can facilitate an analysis of types of books that result in yes, no, or maybe disposition commands.

The seller representative can therefore use the accessed customer purchasing history 406, and/or accessed customer product preferences 408 in view of a seller inventory to specifically select books to be placed in the customer book list. The seller server, through the seller representative workstation receives selections of books specifically selected for the customer.

In an alternative, the seller representative can start with one of the general book lists automatically created at 402 and modify that general book list at 410 in order to tailor a previously general book list to the purchasing history or product preferences of the customer. The general book list can be presented on the graphical display of the seller representative workstation, and the seller server receives selections of books to add or delete from the general book list through the seller representative workstation. In a non-limiting example, the seller representative may take the automatedly generated general book list of “new releases”, which may exemplarily be new titles offered by the seller in the past 30 or 60 days and then refine that general book list to only list those new releases that the seller representative believes would be of particular interest to the customer based upon one or both of the customer's purchasing history and customer's product preferences.

At 412 the seller representative, using the seller representative workstation, selects one or more of the customer book list, general book list, or modified general book list to be provided to the customer. The selected one or more book lists are then provided to the customer at 414 in the same manner as described above with respect to 102 in FIG. 2. Therefore, in some embodiments, the customer may receive a notification that multiple lists have been provided to the customer's secure account, some of which may be automatedly created general book lists that have been selected as being thought to be of interest to the customer, in addition one or more book lists that are specifically tailored to that individual customer, either by modifying an automatedly created general book list from 410 or a newly created customer book list with books selected by the seller representative specifically for that individual customer.

Therefore, embodiments of the method as disclosed herein leverage the communication and access afforded by a communication network such as the Internet to make product sales, while providing a customer interaction and personalization that is currently not available in on-line retail experiences.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of selling products over a network, the method comprising:
creating at least one product list, the product list comprising a plurality of individual products;
providing the at least one product list to a customer through a secure website accessed over the network;
individually presenting a product from the at least one product list to the customer;
receiving a disposition command from the customer for the individually presented product;
upon receiving the disposition command, allocating the product in a customer virtual shopping cart based upon the disposition command and individually presenting a next product from the product list to the customer; and
facilitating completion of an order of the products in the customer virtual shopping cart by the customer.

2. A method of selling books over the internet, the method comprising:
creating at least one customer book list individually tailored to a customer based upon at least one of the customer's purchasing history and the customer's book preferences, the book list comprising descriptions of a plurality of books;
providing the customer book list to the customer by storing the customer book list in a secure customer profile, accessed by the customer through the Internet;
individually presenting a description of a book from the customer book list to the customer;
receiving a disposition command from the customer for the book description from the customer book list;
upon receiving the disposition command, allocating the book in a virtual shopping cart of the customer based upon the received disposition command and individually presenting the description of a next book from the customer book list to the customer; and
facilitating completion of an order of the books in the virtual shopping cart by the customer.

3. The method of claim 2 wherein the disposition command is one of Yes, No, and Maybe, and
wherein if the yes disposition command is received, the book is placed in the virtual shopping cart;
wherein if the no disposition command is received, the book is deleted from the customer book list; and
wherein if the maybe disposition command is received, the book is saved to another client book list.

4. The method of claim 2, further wherein the customer book list is located in the virtual shopping cart of the customer and wherein the disposition command is one of Yes, No, and Maybe; and
wherein if the yes disposition command is received, the book is added to a current order from the virtual shopping cart;
wherein if the no disposition command is received, the book is deleted from the virtual shopping cart; and
wherein if the maybe disposition command is received, the book stays in the virtual shopping cart, but is not added to the current order.

5. The method of claim 2, further comprising:
checking a seller inventory database for available books;
wherein the book list comprises only available books from the seller inventory.

6. The method of claim 2, further comprising notifying the customer that a customer book list has been created and provided in the secure customer profile by an automated electronic message.

7. The method of claim 2, further comprising:
identifying with a seller at least one characteristic of a plurality of books available from the seller;
sorting the plurality of books with the seller server based upon a value for the at least one identified characteristic; and
creating a general book list with the seller server, the books in the general book list all comprising the same value for the at least one identified characteristic.

8. The method of claim 7, wherein creating at least one customer book list further comprises receiving a seller representative modification to the at least one general book list based upon the seller representative's knowledge of the customer to create the at least one customer book list.

9. The method of claim 7, wherein the at least one identified characteristic comprises a book format.

10. The method of claim 7, wherein the at least one identified characteristic comprises a seller release date and the general book list is a list of new releases.

11. The method of claim 2, wherein the customer's book preferences are previously obtained through direct communication with the customer.

12. The method of claim 2, wherein the customer's book preferences are identified by the seller server by analyzing a web page navigation or disposition command history of the customer.

13. A non-transient computer readable medium programmed with computer readable code that upon execution by the computer, causes the computer to:
receive book selections from a seller inventory from a seller representative to create at least one customer book list individually tailored for a customer;
send an automated electronic message to the customer, notifying the customer of the at least one customer book list;
receive secure log in credentials from the customer and upon receiving the secure log in credentials provide the customer access to a secure customer account that includes the at least one customer book list;
individually present each book in the customer book list to the customer and prompt the customer for a disposition command for each individually presented book;
receive a disposition command for each book from the customer;
individually present a next book from the customer book list to the customer;
allocate each book from the customer book list in a virtual shopping cart based upon the received disposition command for each individually presented book; and
facilitate the purchase of the books allocated to the virtual shopping cart by the customer.
